(19) United States
(12) Patent Application Publication
(10) Pub. No.: US 2004/0152523 A1
(43) Pub. Date: Aug. 5, 2004

(54) Motive power transmission device for a radio control model

(76) Inventor: Aling Lai, Taichung (TW)

Correspondence Address: ALING LAI, P.O. BOX 2103, Taichung, TW

(21) Appl. No.: 10/356,014

(22) Filed: Feb. 3, 2003

(51) Int. Cl. F16D 3/26

(52) U.S. Cl. 464/112

(57) ABSTRACT

A motive power transmission device for a radio control model includes a shaft having an enlarged ball-like portion formed on one end of the shaft. A funnel-shaped groove is diametrically defined in and extends through the enlarged ball-like portion. A coupling is connected to the shaft and includes a cavity defined to universally receive the enlarged ball-like portion. Two holes are diametrically defined in the coupling and communicating with the cavity. The two holes communicate with the funnel-shaped groove when the enlarged ball-like portion is received in the cavity in the coupling. An annular groove is defined in an outer periphery of the coupling and communicating with the two holes. A pin extends through the holes and the funnel-shaped groove to connected the shaft with the coupling. A fixing member is received in the annular groove in to hold the pin in place.

### BACKGROUND OF THE INVENTION

1. Field of the Invention

The present invention relates to a motive power transmission device, and more particularly to a motive power transmission device for a radio control model.

2. Description of Related Art

A motive power transmission system for a radio control model shown in FIG. 5 comprises a gear box (81) mounted on a frame (not shown) of the radio control model. The gear box (81) includes two opposite sides each having a linkage (82) pivotally connected to the gear box (81). A bearing seat (83) is pivotally mounted on a free end of the linkage (82) and a first coupling (84) is pivotally mounted in the bearing seat (83) for connecting and driving a wheel (85). The two opposite sides of the gear box (81) each has a second coupling (811) mounted thereon. A shaft (9) has a first end universally connected to the first coupling (84) and a second end connected to the second coupling (811) such that the shaft (9) can drive the wheel (85) via the first coupling (84).

With reference to FIGS. 6-8, an enlarged ball-like portion (91) is formed on the first end of the shaft (9) and the first coupling (84) has a cavity (841) defined for universally receiving the enlarged ball-like portion (91) of the shaft (9). The enlarged ball-like portion (91) has a through hole (912) diametrically defined therein and two grooves (911) defined in the enlarged ball-like portion (91). The two grooves (911) diametrically correspond to each other and respectively communicate with the through hole (912) in the enlarged ball-like portion (91). A pivot axle (92) is pivotally received in the through hole (912) and has a through hole (921) laterally defined in and extending through the pivot axle (92). The through hole (921) in the pivot axle (92) communicates with the groove (911) when the pivot axle (92) received in the through hole (912) in the enlarged ball-like portion (91). A threaded hole (922) is longitudinally defined in the pivot axle (92) and communicates with the through hole (921) in the pivot axle (92). The first coupling (84) includes two holes (842) defined therein and communicating with the cavity (841). The two holes (842) in the first coupling (84) diametrically correspond to each other and communicate with the groove (911) when the enlarged ball-like portion (91) received in the cavity (841). A pin (94) extends through the first coupling (84) and the enlarged ball-like portion (91) via the holes (842) in the first holes (842) and the grooves (911) in the enlarged ball-like portion (91) to connect the shaft (9) and the first coupling (84). A bolt (93) is fully screwed into the threaded hole (922) to hole the pin (94) in place when the shaft (9) is inclined relative to an axis of the first coupling (84).

The conventional motive transmission device for a radio control model has several disadvantages as follow.

1. The pin (94) is positioned by the bolt (93). However, the bolt (93) may be loosened due to the shock from the radio control model during being operated such that the wheel is idled.

2. The pivot axle (92) is necessary to position the pin (94). However, the pivot axle (92) is hard to be manufactured because the pivot axle (92) has a small volume, and the threaded hole (922) and the bore (921) must be defined in the pivot axle (92).

3. The through hole (912) is defined in the enlarged ball-like portion (91) for receiving the pivot axle (92) such that the strength of the structure of the enlarged ball-like portion (91) becomes weak.

4. The bolt (93) must be fully screwed into the threaded hole (922) in the pivot axle (92) to hold the pin (94) in place. However, the enlarged ball-like portion (91) is received in the cavity (841) so that the shaft (9) must be inclined relative to an axis of the first coupling (84) to expose the threaded hole (922) to the user. Consequently, the diameter of the shaft (9) is limited.

The present invention has arisen to mitigate and/or obviate the disadvantages of the conventional motive power transmission device for a radio control model.

### SUMMARY OF THE INVENTION

The main objective of the present invention is to provide an improved motive power transmission device for a radio control model.

To achieve the objective, the motive power transmission device for a radio control model in accordance with the present invention comprises a shaft having an enlarged ball-like portion formed on one end of the shaft. A funnel-shaped groove is diametrically defined in and extends through the enlarged ball-like portion. A coupling is connected to the shaft and includes a cavity defined to universally receive the enlarged ball-like portion. Two holes are defined in the coupling and communicating with the cavity. The two holes diametrically correspond to each other and communicate with the funnel-shaped groove when the enlarged ball-like portion is received in the cavity in the coupling. An annular groove is defined in an outer periphery of the coupling and communicating with the two holes. A pin extends through the holes and the funnel-shaped groove to connected the shaft with the coupling. A fixing member is received in the annular groove in to hold the pin in place.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a motive power transmission device for a radio control model in accordance with the present invention;

FIG. 2 is a cross sectional view of a motive power transmission device for a radio control model in FIG. 1;

FIG. 3 is a cross sectional of the motive power transmission device in FIG. 2 along line 3-3;

FIG. 4 is an exploded perspective view of another embodiment of the motive power transmission device in FIG. 1;

FIG. 5 is a perspective schematic of a motive power transmission device for a radio control model;

FIG. 6 is an exploded perspective view of a conventional motive power transmission device for a radio control model in accordance with the prior art;

FIG. 7 is side a cross sectional view of the conventional motive power transmission device in FIG. 6; and

FIG. 8 is a rear partially cross sectional view of he conventional motive power transmission device in FIG. 6.

### DETAILED DESCRIPTION OF THE INVENTION

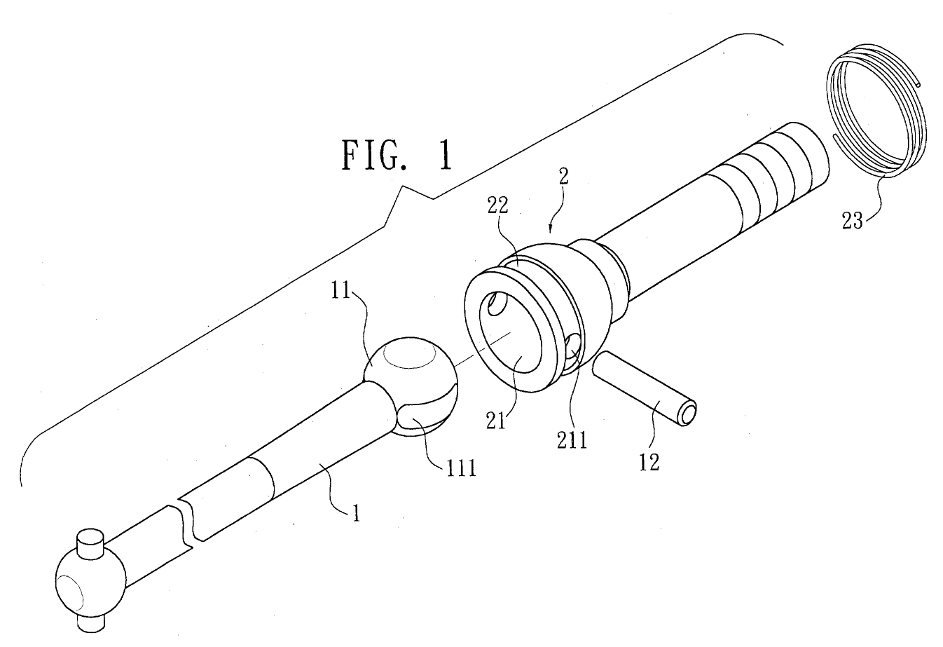

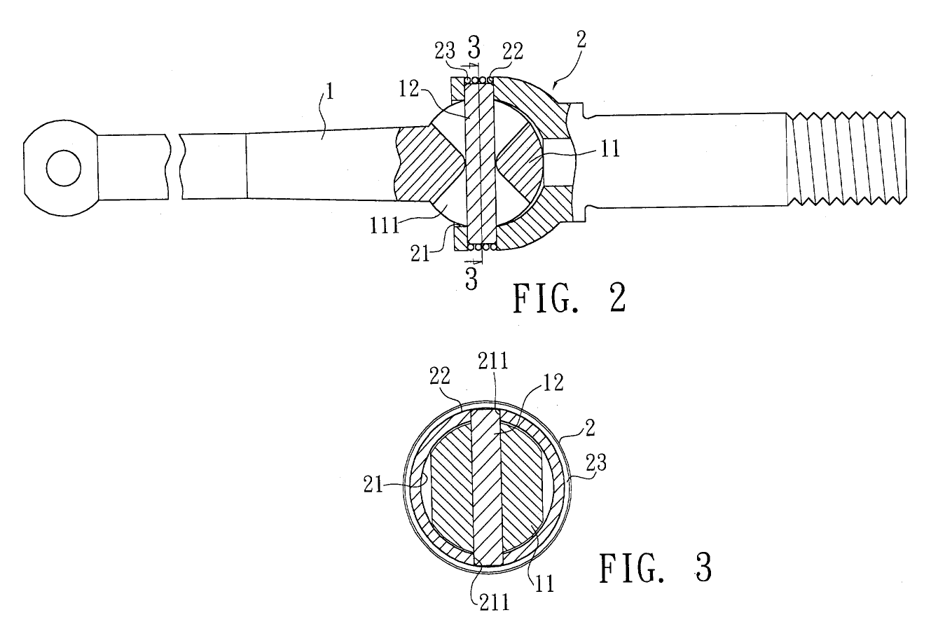

Referring to the drawings and initially to FIGS. 1-3, a motive power transmission device for a radio control model in accordance with the present invention comprises a shaft (1) and a coupling (2) universally connected to the shaft (1).

The shaft (1) has an enlarged ball-like portion (11) formed on a first end of the shaft (1) and received in the coupling (2). The shaft (1) has a second end adapted to be connected to a motor of the radio control model. A funnel-shaped groove (111) is diametrically defined in the enlarged ball-like portion (111) and extending through the enlarged ball-like portion (11) to allow a pin (12) extending through the enlarged ball-like portion (11).

The coupling (2) has a cavity (21) defined in a first end thereof for universally receiving the enlarged ball-like portion (11) of the shaft (1) and two holes (211) laterally defined in the coupling (2). The coupling (2) has a second end adapted to be connected to and drive a wheel of the radio control model. The two holes (211) diametrically correspond to each other and communicate with the cavity (21) in the coupling (2). The two holes (211) communicate with the funnel-shaped groove (111) when the enlarged ball-like portion (11) received in the cavity in the coupling (2). An annular groove (22) is defined in an outer periphery of the coupling (2) and communicates with the two holes (211) in the coupling (2). The pin (12) extends through the hole (211) and the funnel groove (111) to connect the shaft (1) with the coupling (2). The pin (12) has two opposite ends each received in a corresponding one of the two holes (211) in the coupling (2). A fixing member (23) is securely received in the annular groove (22) to prevent the pin (12) from detaching from the coupling (2). In the preferred embodiment of the present invention, the fixing member (23) is a spring. The pin (12) has two opposite ends each against an inner periphery of the fixing member (23) such that the pin (12) never detaches from the coupling (2) even the radio model being operates on a rough supporting surface.

In the structure of the present invention, the enlarged ball-like portion (11) of the shaft (1) only needs to define a funnel-shaped groove to allow the pin extending through the enlarged ball-like portion (11) so that the manufacturing processes are simplified and the manufacturing cost is reduced. Furthermore, there in only one funnel-shaped groove (11I) defined in the enlarged ball-like portion (11) such that the strength of the structure of the present invention is stronger than that of the conventional motive power transmission device for a radio control model. The pivot axle of the conventional motive power transmission device is unnecessary to the present invention such that the diameter of the shaft (1) is not limited and can be suitably enlarged for providing a greater torsion force to the radio control model.

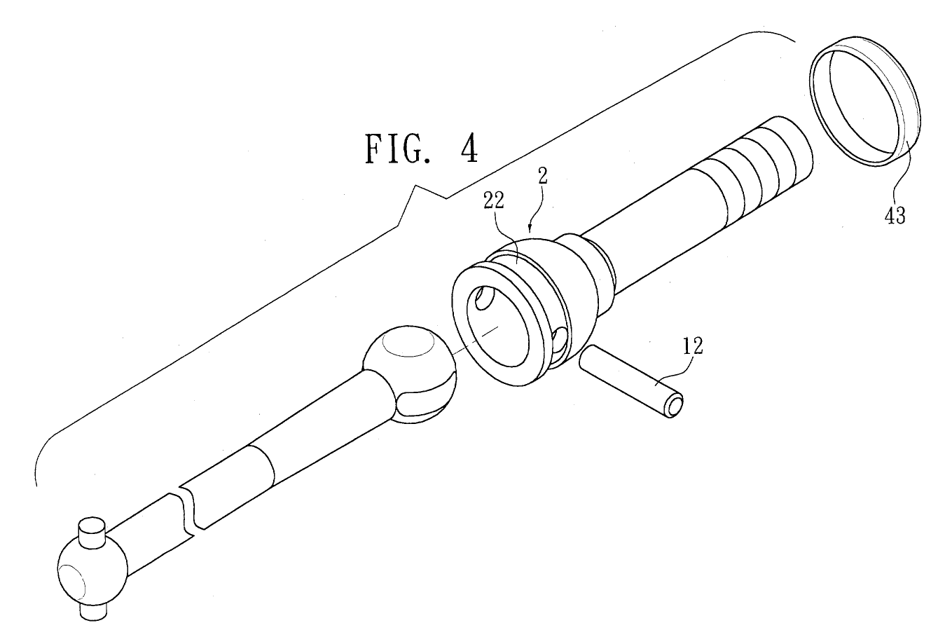

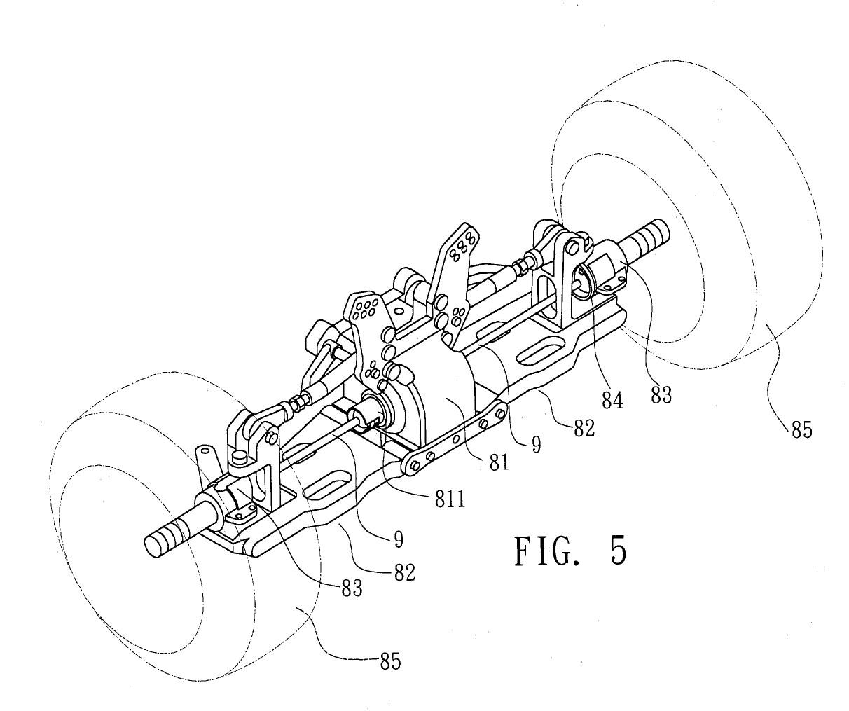

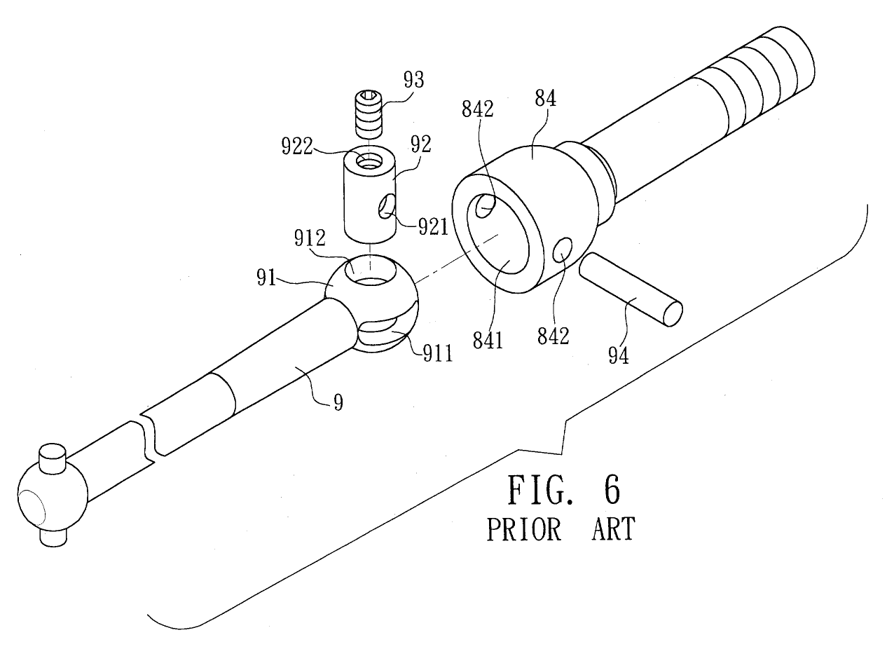

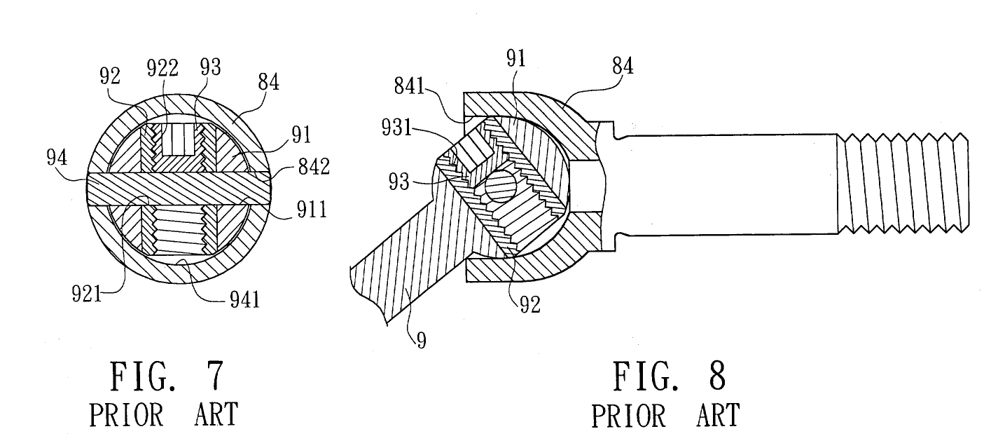

With reference to FIG. 4, for an easy assembling, the fixing member (23) is a hoop (43) that is made of flexible material and received in the annular groove (22) to prevent the pin (12) from detaching from the coupling (2).

Although the invention has been explained in relation to its preferred embodiment, it is to be understood that many other possible modifications and variations can be made without departing from the spirit and scope of the invention as hereinafter claimed.

What is claimed is:

1. A motive power transmission device for a radio control device, comprising:
a shaft including:
a first end having an enlarged ball-like portion formed thereon and a second end adapted to be connected to a motor of the radio control model; and
a funnel-shaped groove diametrically defined in and extending through the enlarged ball-like portion;
a coupling having a first end connected to the shaft and a second end adapted to be connected to and drive a wheel of the radio control model, the coupling:
a cavity defined in the first end of the coupling for universally receiving the enlarged ball-like portion of the shaft;
two holes defined in the first end of the coupling and communicating with the cavity in the coupling, the two holes diametrically corresponding to each other and communicating with the funnel-shaped groove when the enlarged ball-like portion is received in the cavity in the coupling; and
an annular groove defined in an outer periphery of the coupling and communicating with the two holes in the coupling;
a pin extending through the holes in the coupling and the funnel-shaped groove in the enlarged ball-like portion to connected the shaft with the coupling, the pin having two opposite ends each received in a corresponding one of the two holes in the coupling; and
a fixing member received in the annular groove in the coupling to hold the pin in place.

2. The motive power transmission device as claimed in claim 1, wherein the fixing is a spring.

3. The motive power transmission device as claimed in claim 1, wherein the fixing member is a hoop.

4. The motive power transmission device as claimed in claim 3, wherein the hoop is made of flexible material.
